(19) United States
(12) Patent Application Publication
(10) Pub. No.: US 2014/0366918 A1
(43) Pub. Date: Dec. 18, 2014

(54) COMPOSITIONS AND METHODS FOR CLEANING MANAGEMENT

(71) Applicant: Diversey, Inc., Sturtevant, WI (US)

(72) Inventors: Katherine E. Pech, Kenosha, WI (US); Maynard Riley, Racine, WI (US)

(21) Appl. No.: 14/374,414

(22) PCT Filed: Sep. 25, 2012
(86) PCT No.: PCT/US2012/057158

§ 371 Date: Jul. 24, 2014

Related U.S. Application Data
(60) Provisional application No. 61/590,794, filed on Jan. 25, 2012.

(51) Int. Cl. G01N 21/64; B05D 1/02; B05D 3/06; C09K 11/02

(52) U.S. Cl. CPC G01N 21/64; C09K 11/025; B05D 1/02; B05D 3/065
USPC 134/18; 252/301.19; 427/8; 250/459.1

(57) ABSTRACT

Compositions and methods are provided for cleaning management, such as evaluating the cleaning of surfaces. Compositions and methods for controlling or preventing the spreading of biological contamination are also provided. The compositions may include at least one of a fluorescent indicator, an alcohol, and water.

### CROSS-REFERENCE TO RELATED APPLICATIONS

This application claims priority to U.S. Provisional Patent Application No. 61/590,794, filed Jan. 25, 2012, which is incorporated herein by reference in its entirety.

### FIELD

This disclosure relates to compositions and methods for cleaning management, such as evaluating the cleaning of surfaces.

### INTRODUCTION

Although environmental cleaning and disinfecting practices have become a cornerstone of patient care, assessment of actual compliance with such procedures has not been reported. During the past decade controlling and limiting the spread of health care associated pathogens have become some of the most challenging aspects of health care epidemiology. Unfortunately the continuing escalation of infections with these pathogens has led to more than 1.5 million people developing resistant hospital acquired, i.e., nosocomial, infections in the U.S. annually. Despite enhancement of hand hygiene through the development of user-friendly alcohol-based hand cleansers, the manner in which they are used and the difficulty achieving appropriate compliance with their use potentially limit their effectiveness.

Three pathogens posing significant nosocomial problems are MRSA (Methicillin Resistant Staphylococcus aureus), VRE (Vancomycin Resistant Enterococcus), and Clostridium difficile (C. difficile). Their significance derives from a combination of resistance to presently available treatments and an ability to rapidly spread extensively in the environment around hospitalized patients. MRSA is present in wound infections, which are associated with bed sores and catheters. VRE is present in bowel and urinary tract infections. C. difficile is also present in bowel infections and presents as severe diarrhea. For each of these pathogens, control with present antibiotics is problematic, if not impossible.

Although screening-based isolation practices have been advocated to limit the transmission of MRSA and VRE, there are logistical issues and concerns about the practical application and cost effectiveness of such practices. Reliance on such practices may alter the epidemiology but not the incidence of health care associated infections. Additionally, outbreak persistence as well as significant environmental contamination occurs despite patients being in isolation for VRE and MRSA as well as for patients who are asymptomatically colonized with C. difficile for which screening is not feasible. These programmatic as well as pathogen-based issues clearly have limited the effectiveness of current as well as proposed isolation practices.

Enhancement of existing cleaning and disinfection practices deserves further consideration and evaluation. Although it is not currently feasible to define the independent role of the hospital environment in the transmission of health care associated pathogens except in isolated investigations, numerous studies over the past twenty years have confirmed the frequent contamination of many surfaces in the near patient environment with hospital associated pathogens able to survive on inanimate surfaces for weeks to months.

With respect to individual pathogens, it has been found that high rates of environmental contamination with C. difficile have been associated both with symptomatic as well as asymptomatic patients. Direct evaluation of the role of environmental contamination in the transmission of C. difficile found a strong correlation with the intensity of environmental contamination, and outbreaks of C. difficile infection have been successfully terminated by enhanced cleaning/disinfecting activities.

The role of environmental contamination in transmission of VRE has been documented. Recent studies have confirmed the frequency of environmental contamination, shown to be highly correlated with the number of body sites colonized as well as with the intensity of gastrointestinal tract colonization. Furthermore the ease with which gloved hands can become contaminated by limited contact with a colonized patient's bed rail and bedside table, the rapid recontamination of surfaces in the near patient environment with VRE despite effective daily cleaning even in the absence of diarrhea as well as the termination of a VRE outbreak in an ICU through enhanced cleaning activities support the likely importance of the environment in the epidemiology of VRE.

MRSA is frequently found in the environment of both colonized and infected patients and colonized health care workers. The pathogen can be transmitted by the gloves of health care providers and increases in concentration in the stool of colonized patients receiving broad spectrum antibiotics. Consequently, it is likely that environmental contamination plays a role in the spread of MRSA. In addition, DNA typing in three studies has supported the likely importance of environmental reservoirs in colonal MRSA outbreaks in hospitals lasting from three months to five years.

These and similar observations confirm the longstanding belief that environmental cleaning/disinfecting activities are important in providing an optimally safe environment for patients and have led to the development of specific guidelines for environmental infection control in health care facilities. Environmental disinfecting does work. Materials such as phenolic compounds, quaternary ammonium compounds, chloride disinfectants, and formaldehyde (among others) can kill a wide range of microbial pathogens, work rapidly, and work effectively in clinical settings.

In 2002, the Centers of Disease Control (CDC) recommended that hospitals “thoroughly clean and disinfect environmental medical equipment surfaces on a regular basis.” Similarly, the Society for Health Care Epidemiology of America's position paper regarding enhanced interventions to control the spread of resistant Staphylococcus aureus and Enterococcus recommended that hospitals “ensure” that their institutional methods of disinfecting surfaces be shown to be “adequate.” In 2003, the National Health Service of Great Britain specifically recommended that “cleaning and disinfecting programmes and protocols for environmental surfaces in patient care areas should be defined.”

More recently the draft guidelines for isolation precautions developed by the CDC in 2004 emphasize the importance of environmental cleaning and disinfection activities. Draft guidelines for isolation precautions developed by the CDC emphasize the importance of environmental cleaning and disinfection activities. Although these guidelines specifically state that hospitals “ensure compliance by housekeeping staff with cleaning and disinfecting procedures” and “insure consistent cleaning and disinfection of surfaces in close proximity to the patient and likely to be touched by the patient and health care worker,” they provide no directives regarding the means by which hospitals are to assist their ability to comply with or “ensure” the effectiveness of such activities prospectively.

In a similar manner the Joint Commission for Health Care Accreditation 2004 standard states “hospitals are expected to develop standards to measure staff and hospital performance in managing and improving the environment of care” without defining what specific resources should be utilized to carry out such activities.

In view of the above, there is a need for a non-microbiological methodology to evaluate the thoroughness with which housekeeping activities are carried out in hospitals or other facilities.

### SUMMARY

In certain aspects, provided are compositions for evaluating cleaning of a surface. The compositions may include a fluorescent indicator, at least one of about 0.01% to about 50% of C₁-C₁₂ alcohol, about 0.01% to about 20% betaine, and about 0.01% to about 50% wax, and water.

In certain aspects, provided are compositions for evaluating cleaning of a surface. The compositions may include a fluorescent indicator, at least one of about 2% to about 50% of an alcohol, about 0.01% to about 20% betaine, and about 0.01% to about 50% wax, and water.

In certain aspects, provided are compositions consisting essentially of a fluorescent indicator, an alcohol, and water.

In certain aspects, provided are compositions consisting essentially of a fluorescent indicator, an alcohol, water, and a preservative.

In certain aspects, provided are methods of evaluating cleaning of a surface. The methods may include determining whether a composition including a fluorescent indicator, water, and at least one of an alcohol, a betaine, and a wax, that has been applied to and dried on the surface remains after the surface has been cleaned.

In certain aspects, provided are methods of evaluating cleaning of a surface. The methods may include applying to the surface a composition including a fluorescent indicator, water, and at least one of an alcohol, a betaine, and a wax, to form a dried composition on the surface, and exposing the surface to UV light to determine whether any dried composition remains after the surface has been cleaned.

In certain aspects, provided are methods of evaluating cleaning of a surface. The methods may include applying to the surface a composition including a fluorescent indicator, water, and at least one of an alcohol, a betaine, and a wax, allowing the composition to dry to form a dried composition on the surface, cleaning the surface to remove at least a portion of the dried composition, and exposing the surface to UV light to detect any dried composition remaining on the surface.

In certain aspects, provided are methods of preventing spreading of a biological contamination on a surface. The methods may include determining whether a composition including a fluorescent indicator, water, and at least one of an alcohol, a betaine, and a wax, that has been applied to and dried on the surface remains after the surface has been cleaned.

In certain aspects, provided are methods of preventing spreading of a biological contamination on a surface. The methods may include applying to the surface a composition including a fluorescent indicator, water, and at least one of an alcohol, a betaine, and a wax, to form a dried composition on the surface, and exposing the surface to UV light to determine whether any dried composition remains after the surface has been cleaned.

In certain aspects, provided are methods of preventing spreading of a biological contamination on a surface. The methods may include applying to the surface a composition including a fluorescent indicator, water, and at least one of an alcohol, a betaine, and a wax, allowing the composition to dry to form a dried composition on the surface, cleaning the surface to remove at least a portion of the dried composition, and exposing the surface to UV light to detect any dried composition remaining on the surface.

In certain aspects, provided are kits for evaluating cleaning of a surface. The kit may include a composition including a fluorescent indicator, water, and at least one of an alcohol, a betaine, and a wax, a sprayer to apply the composition, and a UV light.

The disclosure provides for other aspects and embodiments that will be apparent in light of the following detailed description.

### DESCRIPTION OF THE DRAWINGS

FIG. 1 illustrates a dispenser embodying the present invention.

FIG. 2 illustrates the dispenser of FIG. 1 applying a composition to a surface to be cleaned.

FIG. 3 illustrates an ultraviolet (“UV”) light illuminating the surface to be cleaned to fluoresce any composition remaining on the surface.

### DETAILED DESCRIPTION

In a broad sense, the disclosure relates to compositions and methods for cleaning management, such as evaluating the cleaning of surfaces. In some embodiments, the disclosure relates to compositions and methods for controlling or preventing the spreading of biological contamination. Biological contamination may include, but is not limited to, at least one of microbial, bacterial, yeast, fungal, and viral contaminants. Biological contaminants may include Gram-positive bacteria. Biological contaminants may include Gram-negative bacteria. In some embodiments, the biological contamination includes nosocomial pathogens. Examples of biological contaminants include, but are not limited to, methicillin resistant Staphylococcus aureus (MRSA), vancomycin resistant Enterococcus (VRE), vancomycin resistant Staphylococcus aureus, Clostridium difficile, Acinetobacter baumannii, Stenotrophomonas maltophilia, Candida spp. including Candida albicans, Aspergillus spp., Fusarium spp., Trichosporon spp., Malassezia spp., bacterial pneumonia, viral pneumonia, fungal pneumonia, Mycobacterium spp. including Mycobacterium tuberculosis, influenza, Enterococcus spp., Staphylococcus spp., Pseudomonas spp., and Escherichia coli. The inventors have discovered compositions that may be applied to a surface without cross-contamination of surfaces, and without leaving a residue on the surface. The compositions and methods described herein may be useful, for example, for ensuring cleaning of environments for immunocompromised patients in, for example, hospitals.

Compositions and methods as disclosed herein for determining, managing, and evaluating cleaning may be distinguished from compositions and methods for determining, managing, and evaluating cleanliness. Cleaning may refer to whether or not a surface has been cleaned, by cleaning personnel, for example. Cleanliness may refer to a measure of contamination on a surface, such as a measure of bacteria. Cleanliness may be determined and evaluated by means known in the art such as culture-based testing and microbiologic testing and ATP bioluminescence.

Compositions

In certain embodiments, provided are compositions comprising at least one of a fluorescent indicator, an alcohol, and water.

Suitable compositions may be at least one of or all of the following: 1) fully removable by cleaning after being applied to a surface for a period of time (e.g., at least about 10 minutes, at least about 1 hour, at least about 3 hours, at least about 6 hours, at least about 12 hours, at least about 18 hours, at least about 24 hours, at least about 30 hours, at least about 36 hours, at least about 42 hours, at least about 48 hours etc.); 2) not visible in ambient light upon application to a surface; 3) visible after application to the surface with exposure to UV light; and 4) able to be easily sprayed onto a surface of interest.

The fluorescent indicator may be colorless in ambient light and visible only when exposed to UV light. Therefore, when the composition comprising the fluorescent indicator is applied to a surface in ambient light, the fluorescent indicator may not be detected. Once the composition is exposed to UV light, however, the fluorescent indicator may be detected.

The fluorescent indicator may be any fluorescent indicator or dye known in the art. The fluorescent indicator may comprise a fluorophore. Fluorophores include, but are not limited to, a cyanine (e.g., CyDyes such as Cy3 or Cy5); heterocyclic dyes such as fluorescein, rhodamine, and coumarin; other optical brighteners such as triazine-stilbenes, imidazolines, diazoles, triazoles, benzoxazolines, benzoxazoles, bisbenzoxazoles, butylbenzoxazoles, and biphenyl-stilbenes; a fluorescent protein or functional fragment thereof. Fluorescent indicators include, but are not limited to, CHROMATINT® Fluorescent Tracer 0556 (Chromatech, Inc., Canton, Mich.); LIQUITINT® Green GG (Milliken Chemical, Spartanburg, S.C.); INVISIBLE INK™ (Black Light World, Cub Run, Ky.); invisible blue ink; as well as LUWS21, LUWS1, LUDORA, LUDPIN, LUWS20, and LUWS8 (LuminoChem, Budapest, Hungary).

In certain embodiments, the fluorescent indicator may further comprise a moiety that specifically binds at least a portion of the biological contamination, including but not limited to, DNA, protein, nucleic acids, amino acids, lipids, glycoproteins, and carbohydrates of the biological contamination.

The compositions may comprise fluorescent indicator in an amount of at least about 0.1%, at least about 0.5%, at least 1.0%, at least about 1.5%, at least about 2.0%, at least about 2.1%, at least about 2.2%, at least about 2.3%, at least about 2.4%, at least about 2.5%, at least about 2.6%, at least about 2.7%, at least about 2.8%, at least about 2.9%, at least about 3.0%, at least about 3.1%, at least about 3.2%, at least about 3.3%, at least about 3.4%, at least about 3.5%, at least about 3.6%, at least about 3.7%, at least about 3.8%, at least about 3.9%, or at least about 4.0% by weight. The compositions may comprise fluorescent indicator in an amount of less than about 25%, less than about 20%, less than about 15%, less than about 12%, less than about 10.0%, less than about 9.9%, less than about 9.8%, less than about 9.7%, less than about 9.6%, less than about 9.5%, less than about 9.4%, less than about 9.3%, less than about 9.2%, less than about 9.1%, less than about 9.0%, less than about 8.9%, less than about 8.8%, less than about 8.7%, less than about 8.6%, less than about 8.5%, less than about 8.4%, less than about 8.3%, less than about 8.2%, less than about 8.1%, less than about 8.0%, less than about 7.9%, less than about 7.8%, less than about 7.7%, less than about 7.6%, less than about 7.5%, less than about 7.4%, less than about 7.3%, less than about 7.2%, less than about 7.1%, less than about 7.0%, less than about 6.9%, less than about 6.8%, less than about 6.7%, less than about 6.6%, less than about 6.5%, less than about 6.4%, less than about 6.3%, less than about 6.2%, less than about 6.1%, or less than about 6.0% by weight. The compositions may comprise fluorescent indicator in an amount of about 0.1% to about 10%, about 0.5% to about 9%, about 1% to about 9%, about 2% to about 8%, about 3% to about 7%, or about 4% to about 6% by weight. In certain embodiments, the compositions comprise fluorescent indicator in an amount of about 5% by weight.

The compositions may also comprise an alcohol. The alcohol may be a C₁-C₁₂ alcohol. “C₁-C₁₂” refers to groups containing 1 to 12 carbon atoms. The alcohol may be an alkyl alcohol. “Alkyl” refers to a saturated aliphatic hydrocarbon including straight chain and branched chain groups. “Alkyl” may be exemplified by groups such as methyl, ethyl, n-propyl, isopropyl, n-butyl, and the like. Alkyl groups may be substituted or unsubstituted. Substituents may also be themselves substituted. When substituted, the substituent group is preferably, but not limited to, C₁-C₄ alkyl, aryl, amino, cyano, halogen, alkoxy or hydroxyl. The compositions may comprise a C₁-C₁₂ alkyl alcohol. The compositions may comprise lower alkyl alcohols. “Lower alkyl” refers to C₁-C₄ alkyl. “C₁-C₄ alkyl” refers to alkyl groups containing 1 to 4 carbon atoms. The lower alkyl alcohol may be a C₃-C₄ alkyl alcohol. In certain embodiments, the lower alkyl alcohol comprises isopropyl alcohol. In certain embodiments, the compositions do not include ethanol, which may inhibit the removability of the composition from the surface.

The alcohol may improve evaporation of the composition and reduce drying time of the composition. For example, the composition applied to a surface may dry on the surface in less than about 48 h, less than about 36 h, less than about 24 h, less than about 12 h, less than about 6 h, less than about 4 h, less than about 2 h, less than about 1 h, less than about 45 min, less than about 30 min, less than about 15 min, less than about 10 min, less than about 5 min, less than about 2 min, less than about 1 min, less than about 30 seconds, or less than about 10 seconds.

The compositions may comprise alcohol in an amount of at least about 0.1%, at least about 0.5%, at least 1.0%, at least about 1.5%, at least about 2.0%, at least about 2.1%, at least about 2.2%, at least about 2.3%, at least about 2.4%, at least about 2.5%, at least about 2.6%, at least about 2.7%, at least about 2.8%, at least about 2.9%, at least about 3.0%, at least about 3.1%, at least about 3.2%, at least about 3.3%, at least about 3.4%, at least about 3.5%, at least about 3.6%, at least about 3.7%, at least about 3.8%, at least about 3.9%, or at least about 4.0% by weight. The compositions may comprise alcohol in an amount of less than about 70%, less than about 65%, less than about 60%, less than about 55%, less than about 50%, less than about 45%, less than about 40%, less than about 35%, less than about 34%, less than about 33%, less than about 32%, less than about 31%, less than about 30%, less than about 29%, less than about 28%, less than about 27%, less than about 26%, less than about 25%, less than about 24%, less than about 23%, less than about 22%, less than about 21%, less than about 20%, less than about 19%, less than about 18%, less than about 17%, less than about 16%, less than about 15%, less than about 14%, less than about 13%, less than about 12%, less than about 11%, less than about 10.0%, less than about 9.9%, less than about 9.8%, less than about 9.7%, less than about 9.6%, less than about 9.5%, less than about 9.4%, less than about 9.3%, less than about 9.2%, less than about 9.1%, less than about 9.0%, less than about 8.9%, less than about 8.8%, less than about 8.7%, less than about 8.6%, less than about 8.5%, less than about 8.4%, less than about 8.3%, less than about 8.2%, less than about 8.1%, less than about 8.0%, less than about 7.9%, less than about 7.8%, less than about 7.7%, less than about 7.6%, less than about 7.5%, less than about 7.4%, less than about 7.3%, less than about 7.2%, less than about 7.1%, less than about 7.0%, less than about 6.9%, less than about 6.8%, less than about 6.7%, less than about 6.6%, less than about 6.5%, less than about 6.4%, less than about 6.3%, less than about 6.2%, less than about 6.1%, or less than about 6.0% by weight. The compositions may comprise alcohol in an amount of about 0.1% to about 50%, about 0.1% to about 45%, about 0.1% to about 40%, about 0.1% to about 35%, about 0.1% to about 30%, about 0.1% to about 25%, about 0.1% to about 20%, about 0.1% to about 15%, about 0.1% to about 10%, about 0.5% to about 9%, about 1% to about 9%, about 2% to about 8%, about 3% to about 7%, or about 4% to about 6% by weight. In certain embodiments, the compositions comprise alcohol in an amount of about 5% by weight. The composition may comprise alcohol in an amount sufficient to reduce drying time and improve evaporation, but less than an amount that prevents removability of the composition from the surface.

The compositions may also comprise water (including deionized water). The balance of the composition may be water. The amount of water in the composition may be less than about 99.9%, less than about 99.8%, less than about 99.7%, less than about 99.6%, less than about 99.5%, less than about 99.4%, less than about 99.3%, less than about 99.2%, less than about 99.1%, less than about 99.0%, less than about 98.5%, less than about 98.0%, less than about 97.5%, less than about 97.0%, less than about 96.5%, less than about 96.0%, less than about 95.5%, less than about 95.0%, less than about 94.5%, less than about 94.0%, less than about 93.5%, less than about 93.0%, less than about 92.5%, less than about 92.0%, less than about 91.5%, less than about 91.0%, less than about 90.5%, or less than about 90.0%. The amount of water in the composition may be at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, or at least about 85%. The amount of water in the composition may about 10% to about 99.9%, about 15% to about 99.8%, about 20% to about 99.7%, about 25% to about 99.6%, about 30% to about 99.5%, about 35% to about 99.0%, about 40% to about 98.5%, about 45% to about 98.0%, about 50% to about 97.5%, about 55% to about 97.0%, about 60% to about 96.5%, about 65% to about 96.0%, about 70% to about 95.5%, about 75% to about 95.0%, about 80% to about 95%, or about 85% to about 95%.

In certain embodiments, the compositions may further comprise a preservative. Preservatives may include, but are not limited to, antimicrobials, biocides, and salts. For example, preservatives may include, but are not limited to, KATHON™ Preservatives (mixtures including methylchloroisothiazolinone and methylisothiazolinone from Dow Chemical, Midland, Mich.); NEOLONE 950™ (methylisothiazolinone from Dow Chemical, Midland, Mich.); DMDM hydantoin (available as GLYDANT™ from Lonza, Allendale, N.J.); iodopropynyl butylcarbamate; formaldehyde; benzoic esters (parabens), such as methylparaben, propylparaben, butylparaben, ethylparaben, isopropylparaben, isobutylparaben, benzylparaben; 2-bromo-2-nitropropane-1,3-diol; benzoic acid; and those known to those skilled in the art.

The compositions may comprise preservative in an amount of at least about 0.01%, at least about 0.02%, at least 0.03%, at least about 0.04%, or at least about 0.05% by weight. The compositions may comprise preservative in an amount of less than about 2.0%, less than about 1.5%, less than about 1.0%, less than about 0.5%, or less than about 0.1% by weight. The compositions may comprise preservative in an amount of about 0.01% to about 2.0%, about 0.03% to about 1.0%, about 0.05% to about 0.5%, or about 0.05% to about 0.1% by weight. In certain embodiments, the compositions comprise preservative in an amount of about 0.07% by weight.

In certain embodiments, the compositions further comprise a surfactant or wetting agent to improve wetting. The surfactant may include any suitable surfactants such as nonionic, anionic, cationic, amphoteric, and zwitterion surfactants. In certain embodiments, the surfactant comprises sodium lauryl sulfate (SLS), sodium linear alkyl benzene sulphonate (LAS), sodium lauryl ether sulfate, alcohol ethoxylates, or betaines such as alkyl dimethyl betaine and cocodimethyl amidopropyl betaine. In certain embodiments, the composition includes no surfactants.

Examples of nonionic surfactants include, but are not limited to, amides, alkanolamides, amine oxides, block polymers, alkoxylated primary and secondary alcohols, alkoxylated alkylphenols, alkoxylated fatty esters, sorbitan derivatives, glycerol esters, propoxylated and alkoxylated fatty acids, alcohols, and alkyl phenols, glycol esters, polymeric polysaccharides,

Nonionic surfactants are conventionally produced by condensing ethylene oxide with a hydrocarbon having a reactive hydrogen atom, e.g., a hydroxyl, carboxylic acid group, primary and secondary amino, or primary or secondary amido group, in the presence of an acidic or basic catalyst. Nonionic surfactants may have the general formula RA(CH₂CH₂O)ₙH wherein R represents the hydrophobic moiety, A represents the group carrying the reactive hydrogen atom and n represents the average number of ethylene oxide moieties. R may be a primary or a secondary, straight or slightly branched, aliphatic alcohol having from about 8 to about 24 carbon atoms. A more complete disclosure of nonionic surfactants can be found in U.S. Pat. No. 4,111,855, Barrat, et al., issued Sep. 5, 1978, and U.S. Pat. No. 4,865,773, Kim et al., issued Sep. 12, 1989, which are hereby fully incorporated by reference.

Other nonionic surfactants useful in the composition include ethoxylated alcohols or ethoxylated alkyl phenols of the formula R(OC₂H₄)ₙOH, wherein R is an aliphatic hydrocarbon radical containing from about 8 to about 18 carbon atoms or an alkyl phenyl radical in which the alkyl group contains from about 8 to about 15 carbon atoms, and n is from about 2 to about 14. Examples of such surfactants include alcohol C_{12/13-14/15} ethoxylates and alcohol C₉₋₁₁ ethoxylates. Examples of such surfactants are further listed in U.S. Pat. No. 3,717,630, Booth, issued Feb. 20, 1973, U.S. Pat. No. 3,332,880, Kessler et al., issued Jul. 25, 1967, and U.S. Pat. No. 4,284,435, Fox, issued Aug. 18, 1981, which are hereby fully incorporated by reference.

Moreover, other nonionic surfactants include the condensation products of alkyl phenols having an alkyl group containing from about 8 to about 15 carbon atoms in either a straight chain or branched chain configuration with ethylene oxide, said ethylene oxide being present in an amount from about 2 to about 14 moles of ethylene oxide per mole of alkyl phenol. The alkyl substituent in such compounds can be derived, for example, from polymerized propylene, diisobutylene, and the like. Examples of compounds of this type include nonyl phenol condensed with about 9 moles of ethylene oxide per mole of nonyl phenol, dodecyl phenol condensed with about 8 moles of ethylene oxide per mole of phenol, and the commercially available T-DET® 9.5 marketed by Harcros Chemicals Incorporated.

Other useful nonionic surfactants are the condensation products of aliphatic alcohols with from about 2 to about 14 moles of ethylene oxide. The alkyl chain of the aliphatic alcohol can either be straight or branched, primary or secondary, and may contain from about 8 to about 18 carbon atoms. Examples of such ethoxylated alcohols include secondary alcohol nonionic surfactants such as ENS-70, the condensation product of myristyl alcohol condensed with about 9 moles of ethylene oxide per mole of alcohol, and the condensation product of about 7 moles of ethylene oxide with coconut alcohol (a mixture of fatty alcohols with alkyl chains varying in length from 10 to 14 carbon atoms). Examples of commercially available nonionic surfactants in this type include: Tergitol™ 15-S-7 or 15-S-9 marketed by Union Carbide Corporation; Neodol™ 45-9, Neodol™ 23-6.5, Neodol™ 45-7 and Neodol™ 45-4 marketed by Shell Chemical Company; Kyro EOB marketed by The Procter & Gamble Company; and Berol® 260 and Berol® 266 marketed by Akzo Nobel. Other suitable non-ionic surfactants include Neodol™ ethoxylates, commercially available from Shell Chemicals (Houston, Tex.) and Tergitol™ surfactants, commercially available from Dow (Midland, Mich.). A mixture of nonionic surfactants may also be used. Nonionic surfactants may further include alkyl polyglucosides, including C₈₋₁₀ alkyl polyglucosides (such as, for example, TRITON™ BG-10 from Dow Chemical Company, Midland, Mich.).

Examples of anionic surfactants include, but are not limited to, sulfosuccinates and derivatives, sulfates of ethoxylated alcohols, sulfates of alcohols, sulfonates and sulfonic acid derivatives, sulfates and sulfonates of alkoxylated alkylphenols, phosphate esters, and polymeric surfactants. Suitably, anionic surfactants may include, but are not limited to, alkyl sulfate, ether sulfate, alkyl benzene sulfonate, alpha olefin sulfonate, diphenyloxide disulfonate, alkyl naphthalene sulfonate, sulfosuccinate, sulfosuccinamate, naphthalene-formaldehyde condensate, isethionate, N-methyl taurate, phosphate ester, and ether carboxylate.

Cationic surfactants may include amine surfactants, those containing non-quaternary nitrogen, those containing quaternary nitrogen bases, those containing non-nitrogenous bases and combinations thereof. Such surfactants are disclosed in U.S. Pat. No. 3,457,109, Peist, issued Jul. 22, 1969, U.S. Pat. No. 3,222,201, Boyle, issued Dec. 7, 1965 and U.S. Pat. No. 3,222,213, Clark, issued Dec. 7, 1965, which are hereby fully incorporated by reference.

One category of cationic surfactants may include quaternary ammonium compounds with the general formula RXYZ N⁺A⁻, wherein R is an aliphatic or cycloaliphatic group having from 8 to 20 carbon atoms and X, Y and Z are members selected from the group consisting of alkyl, hydroxylated alkyl, phenyl and benzyl. A⁻ is a water soluble anion that may include, but is not limited to, a halogen, methosulfate, ethosulfate, sulfate and bisulfate. The R group may be bonded to the quaternary group through hetero atoms or atom groups such as —O—, —COO—, —CON—, —N—, and —S—. Examples of such compounds include, but are not limited to, trimethyl-hexadecyl-ammonium sulfate, diethyl-octadecyl-phenyl-ammonium sulfate, dimethyl-dodecyl-benzyl-ammonium chloride, octadecylamino-ethyl-trimethyl-ammonium bisulfate, stearylamido-ethyl-trimethyl-ammonium methosulfate, dodecyloxy-methyl-trimethyl-ammonium chloride, cocoalkylcarboxyethyl-di-(hydroxyethyl)-methyl-ammonium methosulfate, and combinations thereof.

Another category of cationic surfactants may be of the di-long chain quaternary ammonium type having the general formula XYRR₁N⁺A⁻, wherein X and Y chains may contain an average of from about 12 to about 22 carbon atoms and R and R₁ may be hydrogen or C1 to C4 alkyl or hydroxyalkyl groups. Although X and Y may contain long chain alkyl groups, X and Y may also contain hydroxy groups or may contain heteroatoms or other linkages, such as double or triple carbon-carbon bonds, and ester, amide, or ether linkages, as long as each chain falls within the above carbon atom ranges.

An additional category of cationic surfactant may include the bis(ethoxylated)ammonium quaternary compounds having the general formula:

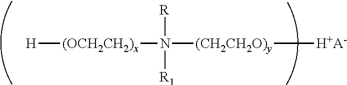

wherein R is methyl, ethyl or propyl group, R₁ is an alkyl group having from 8 to 18 carbon atoms, an alkenyl group having 8 to 18 carbon atoms or mixtures thereof, x is a number from 1 to 40, y is a number from 1 to 40, wherein x+y is between 10 to 60, and A is a water soluble anion. Examples of such compounds include, but are not limited to, alkyl bis(ethoxy)methyl ammonium methyl sulfate (15 moles EO), stearyl methyl bis(ethoxy)ammonium chloride (12 moles EO), stearyl ethyl bis(ethoxy)ammonium ethyl sulfate (15 moles EO), tallow methyl bis(ethoxy)ammonium methyl sulfate (15 moles EO), tallow ethyl bis(ethoxy)ammonium ethyl sulfate (15 moles EO), hydrogenated tallow methyl bis(ethoxy)ammonium chloride (15 moles EO), coco methyl bis(ethoxy)ammonium methyl sulfate (20 moles EO), and combinations thereof.

Other cationic surfactants may include sulfonium, phosphonium, and mono- or tri-long chain quaternary ammonium materials and those described in U.S. Pat. No. 4,259,217, Murphy, issued Mar. 31, 1981, U.S. Pat. No. 4,222,905, Cockrell, Sep. 16, 1980, U.S. Pat. No. 4,260,529, Letton, issued Apr. 7, 1981, U.S. Pat. No. 4,228,042, Letton, issued Oct. 14, 1980, and U.S. Pat. No. 4,228,044, Cushman, issued Oct. 14, 1980, each of which is fully incorporated herein by reference.

Additional cationic surfactants may include ditallowalkyldimethyl (or diethyl or dihydroxyethyl) ammonium chloride, ditallowalkyldimethylammonium methyl sulfate, dihexadecylalkyl (C16) dimethyl (or diethyl, or dihydroxyethyl) ammonium chloride, dioctodecylalkyl (C18) dimethylammonium chloride, dieicosylalkyl (C20) dimethylammonium chloride, methyl (1) tallowalkyl amido ethyl (2) tallowalkyl imidazolinium methyl sulfate (commercially available as Varisoft 475 from Ashland Chemical Company), or mixtures of those surfactants.

Amphoteric surfactants may include betaines and betaine derivatives. Amphoteric surfactants may also include, but are not limited to, amphoteric imadazoline derivatives and fatty amine and fatty amine ethoxylate derivatives. Amphoteric imadazoline derivatives may include, but are limited to, amphodiacetates, amphoacetates, amphocarboxylates, amphopropionate, amphodipropionate, and hydroxypropyl sulfonate. Fatty amine and fatty amine ethoxylate derivatives may include, but are not limited to sultaine, dihydroxyethyl glycinate, aminopropionate, coco amine ethoxylates, polyoxyethylene cocamine, and betaines such as, for example, alkyl betaines, alkylamido betaines, sulfobetaines, N-alkyl betaines, alkyl amidopropyl betaine, cocamidopropyl betaine, lauramidopropyl betaine, and meadowfoamamidopropyl betaine.

Zwitterionic surfactants may include derivatives of secondary and tertiary amines, derivatives of heterocyclic secondary and tertiary amines, or derivatives of quaternary ammonium, quaternary phosphonium or tertiary sulfonium compounds; betaine, including alkyl dimethyl betaine and cocodimethyl amidopropyl betaine; and C₈-C₁₈ amine oxides and sulfo and hydroxy betaines, such as N-alkyl-N,N-dimethylammino-1-propane sulfonate where the alkyl group can be C₈-C₁₈.

Additional surfactants that may be useful according to the invention may be found in U.S. Pat. Nos. 6,054,139, 6,547,063, and 7,572,933, each of which is incorporated herein by reference in their entireties.

The pH of the composition may be at least about 4, at least about 5, at least about 5.1, at least about 5.2, at least about 5.3, at least about 5.4, at least about 5.5, at least about 5.6, at least about 5.7, at least about 5.8, at least about 5.9, at least about 6.0, at least about 6.1, at least about 6.2, at least about 6.3, at least about 6.4, at least about 6.5, at least about 6.6, at least about 6.7, at least about 6.8, at least about 6.9, or at least about 7. The pH of the composition may be less than about 10, less than about 9, less than about 8.9, less than about 8.8, less than about 8.7, less than about 8.6, less than about 8.5, less than about 8.4, less than about 8.3, less than about 8.2, less than about 8.1, less than about 8.0, less than about 7.9, less than about 7.8, less than about 7.7, less than about 7.6, less than about 7.5, less than about 7.4, less than about 7.3, less than about 7.2, less than about 7.1, or less than about 7.0. The pH of the composition may be about about 4 to about 10, about 5 to about 10, about 5 to about 9, or about 6 to about 8. The compositions of the disclosure may be non-corrosive to the surfaces to which they are applied. The compositions of the disclosure may be non-inhibitory or minimally inhibitory to the fluorescent indicators they comprise. As used herein, minimally inhibitory refers to a reduction in activity of less than about 70%, less than about 60%, less than about 50%, less than about 40%, less than about 30%, less than about 20%, less than about 10%, less than about 5%, less than about 2%, or less than about 1%. Compositions having a pH of about 4 to about 10 may be suitably non-corrosive, non-inhibitory, and/or minimally inhibitory. In some embodiments, the compositions have a neutral pH.

The compositions may further comprise at least one optical brightener. Optical brighteners may include, but are not limited to, at least one of Tinopal CBS-X, Ecowhite Nylon FW, Ecowhite FW-8, Optiblanc NL, Leucophor BSB, and Tinopal AMS-GX.

In certain embodiments, the compositions may comprise at least one wax. Suitable waxes include, but are not limited to, polypropylene emulsions such as EPOLENE® E-43 wax (Westlake Chemical, Houston, TX). The compositions may comprise wax in an amount of at least about 0.01%, at least about 0.02%, at least about 0.03%, at least about 0.04%, at least about 0.05%, at least about 0.06%, at least about 0.07%, at least about 0.08%, at least about 0.09%, at least about 0.1%, at least about 0.2%, at least about 0.3%, at least about 0.4%, at least about 0.5%, at least 1.0%, at least about 1.5%, at least about 2.0%, at least about 2.1%, at least about 2.2%, at least about 2.3%, at least about 2.4%, at least about 2.5%, at least about 2.6%, at least about 2.7%, at least about 2.8%, at least about 2.9%, at least about 3.0%, at least about 3.1%, at least about 3.2%, at least about 3.3%, at least about 3.4%, at least about 3.5%, at least about 3.6%, at least about 3.7%, at least about 3.8%, at least about 3.9%, or at least about 4.0% by weight. The compositions may comprise wax in an amount of less than about 50%, less than about 45%, less than about 40%, less than about 35%, less than about 34%, less than about 33%, less than about 32%, less than about 31%, less than about 30%, less than about 29%, less than about 28%, less than about 27%, less than about 26%, less than about 25%, less than about 24%, less than about 23%, less than about 22%, less than about 21%, less than about 20%, less than about 19%, less than about 18%, less than about 17%, less than about 16%, less than about 15%, less than about 14%, less than about 13%, less than about 12%, less than about 11%, less than about 10.0%, less than about 9.9%, less than about 9.8%, less than about 9.7%, less than about 9.6%, less than about 9.5%, less than about 9.4%, less than about 9.3%, less than about 9.2%, less than about 9.1%, less than about 9.0%, less than about 8.9%, less than about 8.8%, less than about 8.7%, less than about 8.6%, less than about 8.5%, less than about 8.4%, less than about 8.3%, less than about 8.2%, less than about 8.1%, less than about 8.0%, less than about 7.9%, less than about 7.8%, less than about 7.7%, less than about 7.6%, less than about 7.5%, less than about 7.4%, less than about 7.3%, less than about 7.2%, less than about 7.1%, less than about 7.0%, less than about 6.9%, less than about 6.8%, less than about 6.7%, less than about 6.6%, less than about 6.5%, less than about 6.4%, less than about 6.3%, less than about 6.2%, less than about 6.1%, or less than about 6.0% by weight. The compositions may comprise alcohol in an amount of about 0.01% to about 50%, about 0.01% to about 45%, about 0.01% to about 40%, about 0.01% to about 35%, about 0.01% to about 30%, about 0.01% to about 25%, about 0.01% to about 20%, about 0.01% to about 15%, about 0.01% to about 10%, about 0.01% to about 9%, about 0.01% to about 9%, about 0.01% to about 8%, about 0.01% to about 7%, about 0.01% to about 6%, about 0.01% to about 5%, about 0.01% to about 4%, about 0.01% to about 3%, about 0.01% to about 2%, or about 0.01% to about 1% by weight.

In certain embodiments, the compositions may include no or substantially no synthetic or natural glues, such as methyl cellulose or ethyl cellulose. The compositions may include no or substantially nomulti-functional organic solvents such polyols and polyamines. Polyols and polyamines may include propylene glycol methyl ether, propylene glycol monomethyl ether, propylene glycol dimethyl ether, and the like. The compositions may comprise 0% by weight synthetic glue, natural glue, and/or multi-functional organic solvent.

The compositions may be colorless or invisible in ambient light, for example, after they have been applied to a surface that is to be cleaned. The compositions, however, may have a bright fluorescence when exposed to UV light. The UV light may originate from any suitable UV source or lamp known in the art. For example, the UV light may originate from a small or pocket-sized UV lamp. For example, the UV light may originate from a battery-operated UV lamp. The UV light may be projected such that the fluorescent indicator is visible on the surface when the UV light source is held less than about 24 inches, less than about 20 inches, less than about 16 inches, or less than about 12 inches away from the surface. The compositions may also be odorless.

In certain embodiments, the compositions do not leave a residue or substantially no residue on the surface after cleaning (e.g., with a cleaning composition). The compositions may be removable by cleaning (e.g., with a cleaning composition) after the composition has been applied to a surface for a period of time. The period of time may be at least about 10 minutes, at least about 1 hour, at least about 3 hours, at least about 6 hours, at least about 12 hours, at least about 18 hours, at least about 24 hours, at least about 30 hours, at least about 36 hours, at least about 42 hours, or at least about 48 hours etc. In certain embodiments, the compositions may be removable from non-porous surfaces. In certain embodiments, the compositions may leave a removable residue on surfaces such as non-porous surfaces. Surfaces may include, but are not limited to, floors, counters, walls, mirrors, sinks, faucets, seats, handles, partitions, rails, telephones, remote controls and call buttons, tables, light switches and light switch covers, door knobs, or other surfaces. Surfaces may further include, but are not limited to, covers for furniture, mattresses, and pillows, such as plastic covers. The surface may comprise materials including, but not limited to, vinyl, polymer or plastic, ceramics, tile, porcelain, metal, marble, terrazzo, linoleum, sealed concrete, rubber, granite, wood, glass, paint, nylon, steel, and laminate or combinations thereof.

These surfaces may be found in hospitals, emergency rooms, doctor offices, dental offices, veterinary offices, laboratories, nursing homes, and other medical and health facilities, as well as assisted living facilities, churches, community centers, daycares, schools, bathrooms and restrooms, locker rooms, offices, kitchens, dining rooms, restaurants, bars, lobbies, and other facilities.

In certain embodiments, the compositions do not leave a residue on the surface after being removed with a suitable cleaning composition. The compositions may be removable from the surface using a suitable cleaning composition using standard cleaning methods. The cleaning composition may be any suitable cleaning composition known in the art. Cleaning compositions may comprise at least one surfactant as described above and including, but not limited to, alkyl polyglucoside (such as, for example, TRITON™ BG-10 from Dow Chemical Company, Midland, Mich.), modified fatty alkaneolamides (such as, for example, NINOL® 1281 from Stepan Company, Northfield, Ill.), coconut diethanolamide (such as, for example, NINOL® 4000 from Stepan Company, Northfield, Ill.), wax, and betaines such as cocobetaine and cocoamidopropyl betaine.

The composition may be formulated for any suitable method of delivery. In certain embodiments, the compositions may be formulated as a wipe, spray, mist, or foam. In certain embodiments, the compositions may be applied to a cloth or a wipe, or formulated as a marker, for application to a surface. The compositions may be in a form that prevents cross-contamination of multiple surfaces. For example, the compositions may be applied without direct contact of the application means to the surface. In certain embodiments, the compositions may be formulated as a spray.

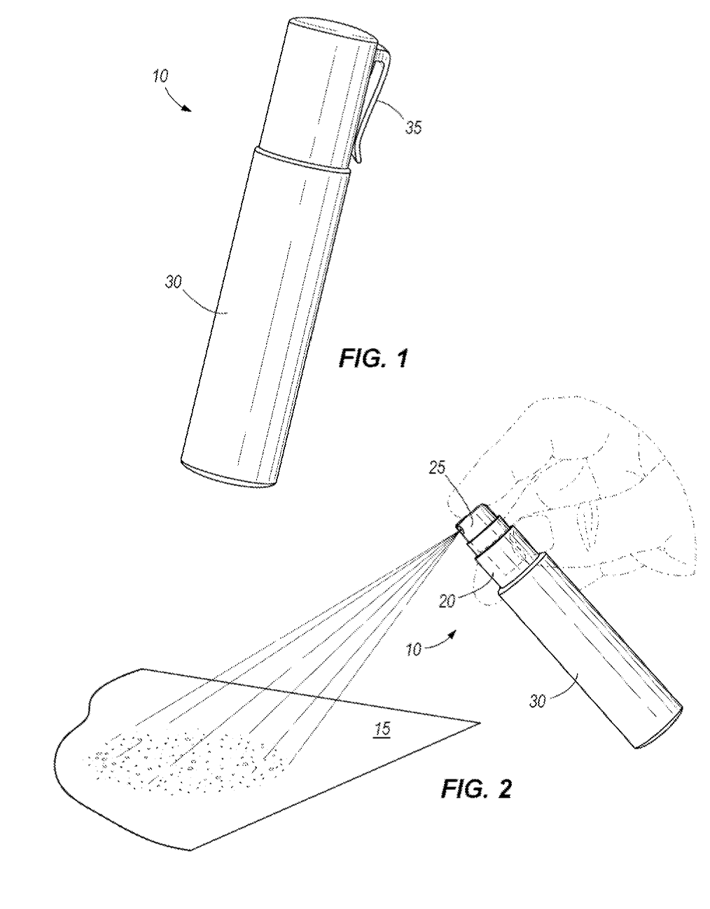

FIGS. 1-3 illustrate an exemplary dispenser 10 that can be used to deliver the composition onto a surface 15 to be cleaned. While the dispenser 10 illustrated in FIG. 1 is a spray dispenser 10 that deposits the composition onto a surface 15 from a short distance away, other types of dispensers can deposit or apply the composition onto the surface 15 in other ways.

With reference to FIG. 1, the dispenser 10 includes a housing 20 that supports a manual pump 25 and that defines a reservoir 30 for the composition. By way of example only, the reservoir 30 can have a capacity that holds approximately 3-20 milliliters. The housing 20 includes clip 35 or similar device for storing the dispenser 10 when not in use, and the housing 20 can be formed of any suitable material (metal, composite, plastic, etc.). Although not shown, the dispenser 10 can support a battery and the pump 25 can be an electrically-actuated manual or automatic pump.

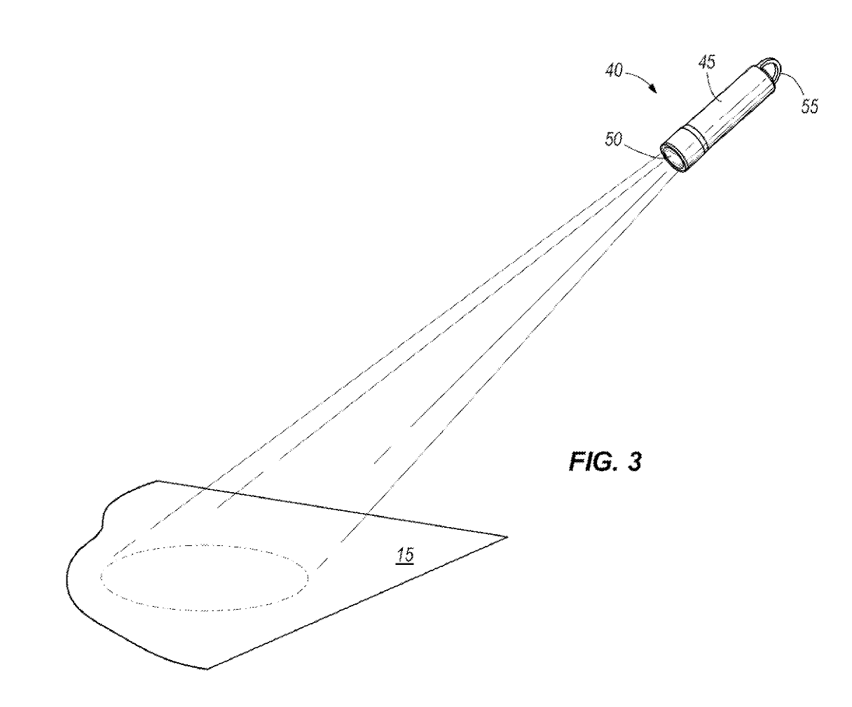

With reference to FIGS. 1-3, each actuation of the pump 25 delivers a relatively small amount of composition, in the form of a spray, to the surface 15 to be cleaned. The deposited composition can be thereafter detected using a light assembly 40. The light assembly 40 includes a light housing 45 that supports an ultraviolet (“UV”) light source 50 and a power source (e.g., batteries) so that the light assembly 40 is portable (movable from room to room). In some circumstances, the light assembly 40 can instead have an electrical cord (not shown) that can be plugged into an outlet (not shown) located in the room being inspected. As shown in FIG. 3, a clip or hook 55 is coupled to the light housing 45 for storing the light assembly 40. In use, the light source 50 projects a beam of UV light to illuminate any composition remaining on the surface 15 after a cleaning operation has been completed to determine whether the surface 15 is clean.

Methods

One aspect of the present disclosure is to provide a system by which management can ensure the quality of cleaning and maintenance services by physically inspecting whether invisible ink markings have been removed by a cleaning person. In some embodiments, an invisible or transparent indicator composition can be applied to a variety of common surfaces, all of which wash away upon normal cleaning for all typical surfaces marked. In some embodiments, the indicator comprises a fluorescent material that is invisible under normal light but is visible upon being exposed to ultra violet light. In accordance with this aspect, one or more areas to be cleaned are marked with the indicator prior to cleaning. After the areas have been cleaned, an inspection is made with ultra violet light to expose the original areas marked and to determine whether the original marks are still there. If so, the area was not properly cleaned. However, if the original mark is gone then the area was cleaned.

In a further aspect, the disclosure relates to methods of evaluating cleaning of a surface. The methods may comprise applying to the surface a composition as described herein, allowing the composition to dry to form a dried composition on the surface, applying a cleaning composition to the surface to remove at least a portion of the dried composition, and exposing the surface to UV light to detect any dried composition remaining on the surface. A determination with the UV light that the dried composition is no longer present may indicate that the surface was properly cleaned with the cleaning composition. A determination with the UV light that the dried composition is still present may indicate that the surface was not properly cleaned with the cleaning composition.

In certain aspects, provided are methods of evaluating cleaning of a surface. The methods may comprise applying to a surface a composition as detailed above to form a dried composition on the surface, and exposing the surface to UV light to determine whether any dried composition remains after the surface has been cleaned. The methods may comprise applying to the surface a composition as detailed above, allowing the composition to dry to form a dried composition on the surface, applying a cleaning composition as described above to the surface to remove at least a portion of the dried composition, and exposing the surface to UV light to detect any dried composition remaining on the surface. A determination with the UV light that the dried composition is no longer present may indicate that the surface was properly cleaned with the cleaning composition. A determination with the UV light that the dried composition is still present may indicate that the surface was not properly cleaned with the cleaning composition.

In certain aspects, provided are methods of preventing spreading of a biological contamination on a surface. The methods may comprise applying to a surface a composition as detailed above to form a dried composition on the surface, and exposing the surface to UV light to determine whether any dried composition remains after the surface has been cleaned. The methods may comprise applying to the surface a composition as detailed above, allowing the composition to dry to form a dried composition on the surface, applying a cleaning composition as described above to the surface to remove at least a portion of the dried composition, and exposing the surface to UV light to detect any dried composition remaining on the surface. A determination with the UV light that the dried composition is no longer present may indicate that the surface was properly cleaned with the cleaning composition. A determination with the UV light that the dried composition is still present may indicate that the surface was not properly cleaned with the cleaning composition. The compositions and methods may be used in any suitable use or environment, such as the surfaces detailed above.

Another aspect of the present invention is the combination of the indicator material and the application technique. Within some industries, contact applicators, such as markers, pens, brushes, and the like, create an opportunity for cross-contamination (i.e., moving germs from one surface or room to another). The non-contact application technique of the present invention solves this problem via a spray applicator. Various formulations have been created specifically for spray application, wherein the indicator composition is consistently sprayable without clogging the spraying device and yet dries quickly and transparently. The compositions are suitably sprayable with the spray applications. For example, the compositions may be sprayed using only one, two, or three squirts or sprays.

The compositions may be wiped, sprayed, misted, or poured on the surface. In certain embodiments, the composition is sprayed on the surface. The composition may be sprayed using any sprayer known in the art. The sprayer may be small. The sprayer may be disposable. The sprayer may be recyclable.

In accordance with a further aspect of the disclosure, a method for control of nosocomial pathogens includes evaluating a cleaning program for a patient-care environment within a facility, enhancing the cleaning program for the patient care environment, and comparing the enhanced cleaning program with at least one other cleaning program. In certain embodiments, evaluating a cleaning program may include training with monitoring surfaces, collecting pre-intervention data, and comparing control within the facility.

In other embodiments, enhancing the cleaning program may include collecting site-specific demographic data, providing education to administrative leadership, senior hospital administration and environmental services staff, implementing a targeted cleaning and disinfection program, evaluating an initial intervention program, obtaining feedback of pre and post intervention results, and assisting with a presentation to the Joint Commission on Accreditation of Healthcare Organizations (JCAHO).

In additional embodiments, comparing the cleaning program may include comparing cleaning within the facility with cleaning within at least one other facility.

In certain aspects, provided are kits for evaluating the cleaning of a surface. The kit may comprise a composition as described above, a sprayer to apply the composition, and a UV light, as described above.

Methods for Making Compositions

The compositions as described above may be mixed using any conventional means known in the art. The components may be combined in any suitable order.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including but not limited to”) unless otherwise noted. All methods described herein can be performed in any suitable order unless otherwise indicated herein or otherwise clearly contradicted by context. The use of any and all examples, or exemplary language (e.g., “such as”) provided herein, is intended merely to illustrate aspects and embodiments of the disclosure and does not limit the scope of the claims.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like. All amounts are by percentage weight unless specified otherwise.

### EXAMPLES

### Example 1

Formulations as detailed in Table 1 were mixed. Each composition was applied to a surface and allowed to dry (24 h). The dried composition was at least substantially colorless and at least substantially not visible in ambient light. The dried composition was visualized with UV light. The dried composition was then cleaned and/or removed with a cleaning composition (e.g., VIREX® II from Diversey, Sturtevant, Wis.). Subsequently, the surface was exposed to UV light again, and substantially no residual composition remained on the surface, which indicated that the surface had been cleaned and that substantially no residual composition remained.

TABLE 1
Formulations.

| Raw | Qty % | | | | | | | | | | | | |
|---|---|---|---|---|---|---|---|---|---|---|---|---|---|
| material | 1 | 2 | 3 | 4 | 5 | 6 | 7 | 8 | 9 | 10 | 11 | 12 | 13 |
| DI Water | 89.93 | 89.83 | 89.83 | 72.93 | 82.93 | 73.83 | 58.83 | 89.93 | 87.93 | 82.93 | 98.43 | 98.43 | 98.43 |
| Ethanol | 5 | 0 | 0 | 15 | 0 | 0 | 0 | 0 | 0 | 5 | 0 | 0 | 0 |
| Isopropanol | 0 | 5 | 5 | 0 | 5 | 15 | 30 | 5 | 0 | 0 | 0 | 0 | 0 |
| Cocamidopropyl | 0 | 0.1 | 0 | 1 | 1 | 0.1 | 0.1 | 0 | 1 | 1 | 0 | 0 | 0 |
| Betaine 30% | | | | | | | | | | | | | |
| Invisible Blue | 0 | 0 | 0 | 11 | 11 | 11 | 11 | 0 | 11 | 11 | 0 | 0 | 0 |
| Ink | | | | | | | | | | | | | |
| LUWS21 | 0 | 0 | 0 | 0 | 0 | 0 | 0 | 0 | 0 | 0 | 1 | 0 | 0 |
| LUWS1 | 0 | 0 | 0 | 0 | 0 | 0 | 0 | 0 | 0 | 0 | 0 | 1 | 0 |
| LUDORA | 0 | 0 | 0 | 0 | 0 | 0 | 0 | 0 | 0 | 0 | 0 | 0 | 1 |
| Chromatint | 5 | 5 | 5 | 0 | 0 | 0 | 0 | 5 | 0 | 0 | 0 | 0 | 0 |
| Fluorescent | | | | | | | | | | | | | |
| Tracer 0556 | | | | | | | | | | | | | |
| E-43 Wax | 0 | 0 | 0.1 | 0 | 0 | 0 | 0 | 0 | 0 | 0 | 0.5 | 0.5 | 0.5 |
| (polypropylene | | | | | | | | | | | | | |
| emulsion) | | | | | | | | | | | | | |
| Kathon CG-ICP | 0.07 | 0.07 | 0.07 | 0.07 | 0.07 | 0.07 | 0.07 | 0.07 | 0.07 | 0.07 | 0.07 | 0.07 | 0.07 |
| TOTAL | 100 | 100 | 100 | 100 | 100 | 100 | 100 | 100 | 100 | 100 | 100 | 100 | 100 |

We claim:

1. A composition for evaluating cleaning of a surface, the composition comprising:
a fluorescent indicator;
at least one of about 0.01% to about 50% of C₁-C₁₂ alcohol, about 0.01% to about 20% betaine, and about 0.01% to about 50% wax; and
water.

2. A composition for evaluating cleaning of a surface, the composition comprising:
a fluorescent indicator;
at least one of about 2% to about 50% of an alcohol, about 0.01% to about 20% betaine, and about 0.01% to about 50% wax; and
water.

3. The composition of claim 2, wherein the alcohol comprises a C₁-C₁₂ alcohol.

4. The composition of any one of the above claims, wherein the alcohol comprises a lower alkyl alcohol.

5. The composition of any one of the above claims, wherein the alcohol comprises a C₃-C₄ alkyl alcohol.

6. The composition of any one of the above claims, wherein the alcohol comprises isopropyl alcohol.

7. The composition of any one of the above claims, wherein the alcohol is present in an amount of about 0.1% to about 30%.

8. The composition of any one of the above claims, wherein the alcohol is present in an amount of about 0.1% to about 10%.

9. The composition of any one of the above claims, wherein the fluorescent indicator is present in an amount of about 3% to about 7% by weight.

10. The composition of any one of the above claims, further comprising a preservative.

11. The composition of any one of the above claims, further comprising at least one surfactant.

12. The composition of any one of the above claims, wherein the composition does not comprise a natural or synthetic glue.

13. The composition of any one of the above claims, wherein the composition does not comprise a multifunctional organic solvent.

14. The composition of any one of the above claims, wherein the composition does not comprise a propylene glycol methyl ether.

15. A composition consisting essentially of:
a fluorescent indicator;
an alcohol; and
water.

16. A composition consisting essentially of:
a fluorescent indicator;
an alcohol;
water; and
a preservative.

17. The composition of claim 15 or 16, wherein the alcohol comprises a C₁-C₁₂ alcohol.

18. The composition of claim 15 or 16, wherein the alcohol comprises a lower alkyl alcohol.

19. The composition of claim 15 or 16, wherein the alcohol comprises a C₃-C₄ alkyl alcohol.

20. The composition of claim 15 or 16, wherein the lower alkyl alcohol comprises isopropyl alcohol.

21. A method of evaluating cleaning of a surface, the method comprising:
determining whether the composition of any one of claims 1-20 that has been applied to and dried on the surface remains after the surface has been cleaned.

22. A method of evaluating cleaning of a surface, the method comprising:
applying to the surface the composition of any one of claims 1-20 to form a dried composition on the surface; and
exposing the surface to UV light to determine whether any dried composition remains after the surface has been cleaned.

23. A method of evaluating cleaning of a surface, the method comprising:
applying to the surface the composition of any one of claims 1-20;
allowing the composition to dry to form a dried composition on the surface;
cleaning the surface to remove at least a portion of the dried composition; and
exposing the surface to UV light to detect any dried composition remaining on the surface.

24. The method of any one of claims 21-23, whereby a determination that the dried composition is no longer present indicates that the surface was properly cleaned, or a determination that the dried composition is still present indicates that the surface was not properly cleaned.

25. A method of preventing spreading of a biological contamination on a surface, the method comprising:
determining whether the composition of any one of claims 1-20 that has been applied to and dried on the surface remains after the surface has been cleaned.

26. A method of preventing spreading of a biological contamination on a surface, the method comprising:
applying to the surface the composition of any one of claims 1-20 to form a dried composition on the surface; and
exposing the surface to UV light to determine whether any dried composition remains after the surface has been cleaned.

27. A method of preventing spreading of a biological contamination on a surface, the method comprising:
applying to the surface the composition of any one of claims 1-20;
allowing the composition to dry to form a dried composition on the surface;
cleaning the surface to remove at least a portion of the dried composition; and
exposing the surface to UV light to detect any dried composition remaining on the surface.

28. The method of any one of claims 25-27, whereby a determination that the dried composition is no longer present indicates that the surface was properly cleaned and biological contamination will not be spread, or a determination that the dried composition is still present indicates that the surface was not properly cleaned and biological contamination may be spread.

29. The method of any one of claims 21-28, wherein the biological contamination comprises a microbial.

30. The method of any one of claims 21-28, wherein the biological contamination is bacterial or viral.

31. The method of any one of claims 21-28, wherein the biological contamination comprises a nosocomial pathogen.

32. The method of any one of claims 21-31, wherein the composition is applied by spraying.

33. The method of any one of claims 21-32, wherein the composition does not leave a residue on the surface after cleaning the surface.

34. The method of any one of claims 21-33, wherein the surface is selected from wood, glass, plastic, porcelain, paint, nylon, steel, and laminate.

35. The method of any one of claims 21-34, wherein the surface is located in a hospital, emergency room doctor office, dental office, veterinary office, laboratory, nursing home, medical or health facility, assisted living facility, church, community center, daycare, school, bathroom, restroom, locker room, office, kitchen, dining room, restaurant, bar, or lobby.

36. A kit for evaluating cleaning of a surface, the kit comprising:
a composition according to any one of claims 1-20;
a sprayer to apply the composition; and
a UV light.

37. A method of evaluating cleaning of a surface, the method comprising:
spraying on the surface a composition comprising a fluorescent indicator, water, and at least one of an alcohol, a surfactant, and a wax to form a dried composition on the surface; and
determining whether the dried composition remains on the surface after the surface has been cleaned.

38. The method of claim 37, wherein determining comprises exposing the surface to UV light to determine whether any dried composition remains after the surface has been cleaned.

39. A method of preventing spreading of a biological contamination on a surface, the method comprising:
spraying on the surface a composition comprising a fluorescent indicator, water and at least one of an alcohol, a surfactant and a wax to form a dried composition on the surface; and
determining whether the dried composition remains on the surface after the surface has been cleaned.

40. The method of claim 39, wherein determining comprises exposing the surface to UV light to determine whether any dried composition remains after the surface has been cleaned.
